(19) United States
(12) Patent Application Publication
(10) Pub. No.: US 2010/0239780 A1
(43) Pub. Date: Sep. 23, 2010

(54) METHOD FOR DYING AND/OR PRINTING ADHESIVE CLOSURE PARTS

(76) Inventors: Jan Tuma, Herrenberg (DE); Konstantinos Poulakis, Hildrizhausen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/733,745

(22) PCT Filed: Oct. 10, 2008
(86) PCT No.: PCT/EP2008/008564

§ 371 Date: Mar. 18, 2010

(30) Foreign Application Priority Data
Nov. 20, 2007 (DE) 102007055428.3

(51) Int. Cl. B41M 1/40; B05D 7/24; B41M 1/30; D06P 5/30; B05D 3/06; B05D 7/02

(52) U.S. Cl. 427/514; 427/422; 427/301; 427/256; 427/355

(57) ABSTRACT

The invention relates to a method for dying and/or printing adhesive closure parts (10) having a plurality of hooking means (12) predominately made of a plastic material connected to a carrier (14), wherein a dye medium is applied to the surface (16) of the adhesive closure part (10) or the parts thereof by means of an application unit (18). Because a dye is used that is based on a solvent-free wax, which is applied by means of the application unit (18) in a melted form in droplets, bubbles, or in pellet form, and that enters into a fixed connection to the surface (16) in the cooled, cured state, a was dye application may be achieved that is markedly colorfast and UV-resistant.

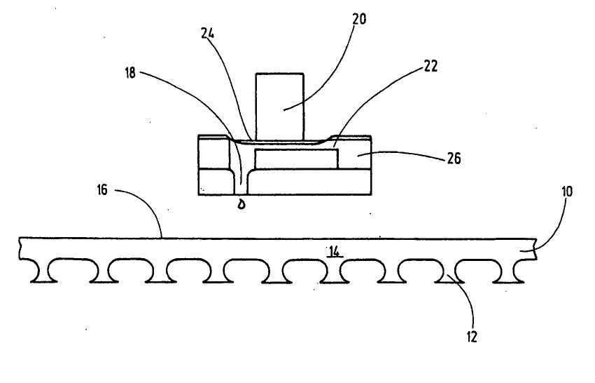

The invention relates to a method for dyeing and/or printing adhesive closure parts having a plurality of interlocking means which are connected to a backing, primarily consisting of a plastic material, a dye medium being applied to the surface of the adhesive closure part or its parts by an application means.

These generally tape-like adhesive closure parts are readily available on the market in a plurality of embodiments. The known adhesive closures generally consist of two parts in the form of male or female engagement parts, the male engagement parts being formed from a hook-shaped or mushroom-shaped closure material as interlocking means on which female engagement parts in the form of a hook or fleece material can be fastened, if the two engagement parts are connected to one another with the formation of the actual adhesive closure. These interlocking means can be repeatedly detached from one another and connected to one another, and the primary applications for these adhesive closures are generally in the clothing industry; but they are also the subject matter of technical applications, for example, as fasteners for wall and panel linings in motor vehicles and the like.

The indicated tape-like adhesive closures can be obtained in one piece from plastic material by conventional forming processes; there is, however, the option of obtaining at least parts of these adhesive closures by weaving and/or knitting from a plastic fiber material. The plastic material used is generally colorless or has a dyed basic shade originating from the extrusion process; this generally makes it difficult to adapt the finished adhesive closure products to color factors, as arise, for example, from fabric colors in the clothing and textile industry. In particular, when only small numbers of adhesive closures of a specific color are required, it poses problems for the manufacturer to set up the entire production process for a small batch with a definable color of the plastic material.

To remedy this situation, EP 1 502 988 A1 has already suggested dyeing and/or printing adhesive closure parts which consist mainly of plastic material by means of dye application nozzles, the ejection of solvent-containing dye being triggered by a piezo crystal. In this way, very small dye volumes, which are in the pictoliter range, can be applied in droplets with a very high application frequency to the respective engagement part of the adhesive band closure. Proceeding from a colorless, preferably transparent base material or one with basic dyeing, dyeing tasks can be performed within a wide scope. Depending on the chosen dye, small numbers of engagement parts can be treated in terms of dye and configuration. Furthermore, it is also possible to implement a specific dye pattern on the engagement part with the respective dye application nozzle so that in this way characters in the form of number or letter sequences can also be applied. In particular, with the known solutions, it is possible to dye or print small production amounts of closure material without the remaining production process for the engagement parts, that is to say, for the interlocking means, being obstructed.

In the known solution, the dyes to be applied are inks, in particular reactive inks, acid inks, or dispersion inks. These inks contain solvents so that they are not especially suitable for marking of adhesive closure parts which are used in the food, cosmetics and pharmaceutical domain. It has also been shown that especially in very long lasting operation with numerous washing processes, the ink used fades; this reduces the clarity of the ink coating with time and leads to an unattractive appearance. The inks are often not lightfast and fade accordingly strongly upon exposure to solar radiation.

Furthermore, WO 98/39 759 A1 discloses a method in which for dyeing and/or printing of adhesive closure parts solvent-based inks, curable inks and water-based inks are used as the dye medium. In U.S. Pat. No. 6,910,353 B2, for a comparable application, water-based inks with acrylate binders are used, which are applied by means of flexographic printing methods. DE 698 13 177 T2 discloses using solvent-free waxes in the form of hot melt ink compositions for printing of porous substrates for producing so-called bar codes.

Proceeding from the aforementioned prior art, the object of the invention is to devise a method for dyeing and/or printing of adhesive closure parts that further improves the known dyeing solutions while maintaining their advantages, such that they also remain lightfast in long-term operation and that increased environmental and health requirements are taken into consideration. This object is achieved by a method with the features of claim 1 in its entirety.

In that, as specified in the invention, the dye medium is one based on a solvent-free wax which is applied in molten form in droplet, bubble, or pellet form by the application means and which, in the cooled, set state, bonds tightly to the surface of the adhesive closure part, as well as to its parts, in terms of process engineering even extremely small numbers of adhesive closure parts can be reliably dyed or printed, this dye application having proven particularly wash-resistant and UV-resistant, even after very long intervals of use.

The method according to the invention, within the scope of wax application, manages without solvents, so that in critical domains such as the food industry, the pharmaceutical or cosmetics industry, for special products such as inserted packages, an adhesive closure part dyed with wax can be easily used. Proceeding from a preferably colorless, transparent plastic material or a plastic material with basic dyeing, dyeing tasks can be performed by wax application within a widely drawn framework. Wax application is very reliable and it is economically efficient to treat even small numbers of adhesive closure parts in terms of dye and configuration. In addition to application of a dye pattern design, the application waxes can also be applied in the form of number or letter sequences so that respective manufacturer data, production information, or the like can be applied to the adhesive closure part.

The application means for the colored wax is preferably at least one wax application nozzle, the ejection of the wax being triggered by a piezo crystal. In this way, very small wax volumes that are in the pictoliter range can be applied in droplets with a very rapid application frequency to the adhesive closure part, as well as to its parts. Another option is to hold the colored wax in the form of individual wax rods which are melted in the hardware interior of the application means and then are supplied to its printing head. The printing heads then spray the application wax in the form of pellets onto the surface of the respective adhesive closure part. In this application method, the colored wax, upon striking the adhesive closure part, is already almost solid again; this has the advantage that in particular for weave-like adhesive closure parts of individual filaments, the wax does not penetrate completely into the fabric such as to fade.

Another application option is to heat the colored wax rapidly to its vaporization temperature (>300° C.) with the result that the wax forms bubbles which in turn collapse and which, in this case, can be explosively ejected out of an application nozzle. This process can be repeated up to 10,000 times per second and, in this way, a high quality printing process for the respective adhesive closure part can also be achieved. However, the piezo application technology mentioned initially has proven to be the most easily managed. The colored application wax dries in fractions of a second on the surface of the adhesive closure part so that any afterdrying or subsequent curing processes are not necessary; this in turn increases the process speed.

In one preferred embodiment of the process according to the invention, each colored wax application nozzle is used for a certain color or shade, and mixed dyes can be produced directly on the surface of the adhesive closure part by means of different wax application nozzles. But it is also possible to supply mixed dyes directly to the product by way of the respective wax application nozzle and to dye it in this way. In order to obtain high dyeing or printing rates, there can be a plurality of wax application nozzles, preferably, the wax application nozzles being located stationary in the application means and the adhesive closure parts to be dyed or printed are routed with a definable speed through the application device and are provided with the dye coating by means of the wax application nozzles.

Plastic materials which can be easily dyed can be acrylates, as well as conventional polyamide, polyester, polyethylene, and polypropylene materials from which otherwise the interlocking means of the tape-like adhesive closure part are obtained produced in one piece as a cast product or by way of conventional knitting-weaving methods.

In a development of the method according to the invention, it can be preferably provided that there be wax application nozzles on the two opposing surfaces of the adhesive closure part so that in this way a dyeing or printing process can take place from two different sides, optionally, with different waxes and dyes. It has also proven especially advantageous before the actual dyeing or printing with the wax to supply the adhesive closure parts to reactive pretreatment for purposes of surface coating or surface functionalization to increase the depth of color.

The method according to the invention for dyeing and/or printing of adhesive closure parts is detailed below using one exemplary embodiment as shown in the drawings. Here, the sole figure shows schematically and not to scale the essential components of a wax application nozzle for dyeing a tape-like adhesive closure part with male engagement parts in the form of mushroom-like interlocking means, wax application taking place on the rear surface of the adhesive closure part.

The method according to the invention is used to dye and/or print adhesive closure parts 10, in the figure as so-called male interlocking means 12, mushroom-like interlocking heads being shown which are an integral component of the tape-like backing 14 for the adhesive closure part 10. The mushroom-like interlocking elements 12 can be joined to a corresponding hook or fleece material as so-called female engagement parts with the formation of an adhesive closure system (not shown), the hook or fleece material detachably interlocking on the edge-side projections of the interlocking elements 12. A production process for these engagement parts is described, for example, in EP 1 309 257 B1 of the applicant. Furthermore, the adhesive closure part in this respect consists of a plastic material which is cast in a screen, for example, in the form of polyethylene in a colorless configuration and therefore almost transparent or the plastic material is provided with a basic color as results from the plastic granulate, from which the adhesive closure part 10 can be produced by way of the indicated known extrusion method. Instead of the adhesive closure part 10 which is cast in a so-called chill-roll method, it can also consist of a woven or knit basic backing structure from which the interlocking means (hooks, mushrooms, loops, etc.) then protrude with a definable projection (not shown).

If, at this point, the intention is to dye or print the pertinent, preferably tape-like adhesive closure part 10, it is not sufficient, in order to handle the plurality of formation tasks, to dye the plastic granulate beforehand, that is, prior to producing the actual adhesive closure part 10, but it is preferable to dye and print the already produced adhesive closure part of plastic material later, especially, if it is considered that often only small numbers (tapes less than 1 m long) of the adhesive closure part 10 with a specific coloring are needed, for example for use in the clothing or packaging industry. In the present case, as shown in the figures, the back surface 16 of the adhesive closure part 10 is dyed or printed accordingly.

In order to meet the aforementioned requirements, the method according to the invention calls for dyeing and/or printing of the adhesive closure part 10 by means of at least one wax application nozzle 18. The ejection of colored wax by the wax application nozzle 18 is triggered by a piezo crystal 20, this ejection of colored wax being in the pictoliter range per triggering cycle of the piezo crystal 20. Since, as is recognized, the piezo crystals 20, however, have very high vibration frequencies, a small application amount is still sufficient to achieve full colored wax application, depending on the plastic material used for the adhesive closure part 10 its also being possible for the applied wax coating to at least partially penetrate slightly into the plastic material on the surface side and, in this way, to saturate the open pores of the plastic material with colored wax.

For the sake of simpler representation, the figure shows only one wax application nozzle 18; for a definitive dyeing or printing process, however, a plurality of nozzles is necessary, and several colored wax application nozzles 18, for example 100 to 200, can be accommodated in one printing head of the overall application means, and with 10 to 20 of such piezo-triggered pressure heads then a high passage rate, in addition to full colored wax application for the adhesive closure part 10 to its rear surface 16, can be achieved with very high printing speeds. Depending on the selected triggering for the piezo crystals 20, it is thus also possible to undertake not only dyeing processes, but also to provide the respective adhesive closure part 10 with a printing pattern, even in the form of an advertizing message, company name imprint, or the like. Instead of the illustrated adhesive closure part 10, there can also be one with hook-shaped closure heads or a female engagement part in the form of a conventional loop closure material (not shown), and these engagement parts can also be obtained by way of the aforementioned weaving processes.

Instead of treating the rear surface of the adhesive closure part 10, it can, of course, also be provided on the opposite top side in the region of the free face sides of the interlocking means 12 with a color coating by means of the coating wax. This also applies to the respective stem material or the free distances between the mushroom-like adhesive closure parts 12. An especially attractive, undistorted design arises, however, by rearward printing according to the exemplary embodiment as shown in the figure.

The dye application nozzle 18 shown in the figure is designed overall as a capillary nozzle and is connected to a pressure chamber 22 to carry fluid, on whose top side a vibration plate acts which can be triggered by the piezo crystal 20. On the indicated piezo crystal 20, therefore, positive and negative voltages are applied to control the wax delivery. If there is no voltage on the piezo crystal 20, the colored wax originating from a storage chamber (not shown) flows via a supply line 26 into the pressure chamber 22. If, at this point, a voltage is applied to the piezo crystal 20, the crystal presses on the colored wax in the pressure chamber 22 by way of the vibration plate 24 and ejects the colored wax through the indicated capillary nozzle 18 onto the rear surface of the adhesive closure part 10. By applying a negative voltage to the piezo crystal 20, the vibration plate 24 moves suddenly back, as a result of which the application of colored wax is abruptly interrupted. The delivered amount of wax can be very precisely metered by the extremely fast voltage change so that, with this application method, resolutions from 100 to 9600 dpi, preferably up to several 10,000 dpi can be achieved. This results in very good printing and wax color quality.

The indicated dyeing and printing method by means of colored wax can be operated more or less continuously and, originating from the production machine, the adhesive closure part 10 can be continuously routed through under the colored wax application means, by obvious triggering of the piezo crystals 20 and by a suitable choice of the wax colors, the dyeing and printing design can be changed during the passage process. Especially advantageously, the colored waxes to be applied are those free of solvent. Furthermore, colored waxes can be used which can preferably be kneaded at 20° C. and which otherwise occur solid to brittle-hard. The respective wax used should have a coarse to finely crystalline structure, should be transparent to opaque to colors in its color formation, but not vitreous. Above 40° C. the colored wax used should melt without decomposing and should be slightly liquid just above the melting point, that is, less viscous. In particular, a highly temperature-dependent consistency and solubility have proven favorable and if the colored wax used can be polished under slight pressure, this enables an aftertreatment possibility in which the surface configuration of the wax can be modified, for example that the wax which has been applied to the adhesive closure part appears shiny. For purposes of aftertreatment, it is also possible to fix the wax, for example, by the applied wax being additionally fixed later with steam and/or with an alkali-containing cold bath and/or by mechanical treatment, for example, by means of a pressing calander which presses on the waxed surface of the adhesive closure part 10. Furthermore, aftertreatment can also be done by means of IR or UV light or by application of intrinsic energy. In addition, it is possible to aftertreat the final product by means of actinic energy.

In order to achieve especially good adhesion of the respective colored wax used on the assignable surface of the adhesive closure part 10, before actually applying the colored wax, a process for surface functionalization of the adhesive closure part 10 should be carried out beforehand. In particular, by means of a proton and/or electron exchange medium, especially in the form of donors or collectors, the surface energy of the adhesive closure part 10 can be modified using high energy such that the chemical physical properties of the adhesive closure material without coating and resistant to ageing can be set by function groups of the exchange medium attaching to the adhesive closure part material. This attachment process of the function groups to the coating wax can be supported by means of a high energy flow, for example, by using high frequency radiation, electrical fields, such as that of a dielectric bather discharge, or by means of plasma-supported fields. Proton and/or electron exchange media, in particular, are substances and groups of substances according to the following list:

F⁻, Cl⁻, N₃⁻, Br⁻, etc.

These exchange media interact especially well with the plastic material for the respective adhesive closure part 10 which is to be produced, if the plastic material belongs to one of the following groups: polyethylenes, polypropylene, polybutenes, as well as polyisobutenes and poly(4-methyl-1-penten(es), polymers of the higher a-olefins, for example poly(1-hexene), poly(1-octene), or poly(1-octadecene). Copolymers from different olefins, for example those from ethylene with propylene, should also be recognized as belonging to these polyolefins. A further good feedstock for the adhesive closure parts to be produced is polyester. If the plastic material used at the time is surface-functionalized with the indicated proton and/or electron exchange medium, especially good bonding of the respective charge wax with the surface 16 of the adhesive closure part 10 can be expected, the change of the surface energy obtained in this way for the adhesive closure part 10 taking place within the surface 16 and not being represented as a coating.

Another approach to surface activation for the plastic material of the adhesive closure part 10 is to actually apply a coating to the indicated surface 16, for example, in the form of fluorine. Fluorine application has proven particularly favorable for later adherence of the colored wax on the adhesive closure part 10. By using fluorine some of these plastics for the adhesive closure part 10 are affected on their surface and, using this effect, the surface 16 of the adhesive closure part 10 for attachment with the colored wax can be modified under controlled conditions. To enhance color depth, it can furthermore be provided that the surface 16 be delivered to reactive cationic pretreatment for purposes of surface modification or that, in addition, so-called hydrotropic substances be applied.

With the method according to the invention even extremely small numbers of adhesive closure parts 10 can be reliably and permanently dyed or printed with the colored wax, this colored wax coating or charge having proven especially wash-resistant and UV-resistant even in long-term operation.

1. A method for dyeing and/or printing adhesive closure parts (10) having a plurality of interlocking means (12) which are connected to a backing (14), primarily consisting of a plastic material, a dye medium being applied to the surface (16) of the adhesive closure part (10) or its parts by an application means (18), characterized in that the dye medium is one based on a solvent-free wax which is applied molten in droplet, bubble, or pellet form by the application means (18) and which in the cooled, cured state bonds tightly to the surface (16).

2. The method according to claim 1, characterized in that wax application by the application means (18) takes place such that when the wax strikes the surface (16) of the adhesive closure part (10), it is almost solid again and cured.

3. The method according to claim 1, characterized in that the colored waxes are those which meet at least the following criteria:
can be kneaded at 20° C.,
solid to brittle-hard,
have a coarse to fine crystalline structure,
are transparent to opaque in terms of color, but not vitreous,
melt above 40° C. without decomposing,
is slightly liquid (less viscous) above the melting point,
have a strongly temperature-dependent consistency and solubility, and
can be polished under slight pressure.

4. The method according to claim 3, characterized in that the colored waxes are those which represent esters of higher, even-numbered fatty acids (C16 to C18) with higher fatty alcohols (C16 to C36).

5. The method according to claim 1, characterized in that the surface (16) of the adhesive closure part (10) or parts thereof are functionalized for better adherence of the colored wax and/or that the surface is provided with an active coating.

6. The method according to claim 1, characterized in that the application means has at least one wax application nozzle (18) whose ejection of wax is triggered by a piezo crystal (20).

7. The method according to claim 6, characterized in that each wax application nozzle (18) is used for obtaining a certain color or shade and that mixed colors are supplied by means of different wax application nozzles (18) which induce the application of mixed colors directly on the surface (16) of the adhesive closure part (10).

8. The method according to claim 1, characterized in that wax application is induced on the surface (16) of the backing (14) of the adhesive closure part (10) which faces away from the interlocking means (12) of the adhesive closure part (10).

9. The method according to claim 1, characterized in that fixing or aftertreatment of the wax which has been applied to the surface (16) of the adhesive closure part (10) is effected by means of a fixing or polishing means or by applying intrinsic or actinic energy and by means of UV or IR light.
